(19) United States
(12) Patent Application Publication
(10) Pub. No.: US 2023/0046810 A1
(43) Pub. Date: Feb. 16, 2023

(54) Heating Apparatus

(71) Applicant: JT International SA, Geneva (CH)

(72) Inventors: Andrew Robert John Rogan, Forres (GB); Kyle Adair, Lisburn (GB)

(73) Assignee: JT International SA, Geneva (CH)

(21) Appl. No.: 17/785,769

(22) PCT Filed: Dec. 18, 2020
(86) PCT No.: PCT/EP2020/087304

§ 371 Date: Jun. 15, 2022

(30) Foreign Application Priority Data
Dec. 19, 2019 (EP) 19218300.2

(51) Int. Cl. A24F 40/46; H05B 3/20; A24F 40/10; A24F 40/485; A24F 40/44; A24F 40/60

(52) U.S. Cl. CPC A24F 40/46; H05B 3/20; A24F 40/10; A24F 40/485; A24F 40/44; A24F 40/60; H05B 2203/021

(57) ABSTRACT

A heating apparatus for an aerosol generating device comprising includes a heating element supported within a housing and extending along the length of the housing and an air flow path arranged to transport air over the heating element, wherein the air flow path includes an air inlet located on a lateral portion of the housing with respect to the length of the housing.

### CROSS-REFERENCE TO RELATED APPLICATIONS

The present application is a national phase entry under 35 U.S.C. § 371 of International Application No. PCT/EP2020/087304, filed Dec. 18, 2020, published in English, which claims priority to European Application No. 19218300.2 filed Dec. 19, 2019, the disclosures of which are incorporated herein by reference.

### FIELD OF THE INVENTION

The present invention relates to a heating apparatus for an aerosol generating device, such as an electronic cigarette.

### BACKGROUND

Electronic cigarettes that vaporise a vaporizable liquid are becoming popular as consumer devices. They usually include a device body, a heating apparatus, and a power supply to deliver power to the heating apparatus. The heating apparatus generally comprises a heating element, a housing to support the heating element, a liquid supply, and an air flow path connecting an air inlet and outlet disposed at opposite ends of the heating apparatus. Often the heating apparatus may be in the form of a replaceable cartridge. During typical operation, inhalation by a user draws air through the air inlet and along the length of the housing. The heating element is configured to heat and vaporise liquid supplied from the liquid supply, such that air flowing over the heating element will transport the vaporised liquid out of the air outlet and into the mouth of the user.

However, existing electronic cigarettes and aerosol generating devices are known to be susceptible to leakage. Vaporisable liquid or condensed vapour generated by the heating element will often flow along the length of the housing before exiting the heating apparatus through the air inlet, i.e. leak through the base of the cartridge. Moreover, known devices offer the user very little control over the properties of the generated vapour.

### SUMMARY

An object of the present invention is to address some of these issues.

According to an aspect of the invention there is provided a heating apparatus for an aerosol generating device, comprising a heating element supported within a housing and extending along the length of the housing, and an air flow path arranged to transport air over the heating element, wherein the air flow path comprises an air inlet located on a lateral portion of the housing with respect to the length of the housing.

In this way, liquid is prevented from leaking from the heating apparatus as the liquid will follow a downward path influenced by gravity. Prior art devices are typically configured such that air passes straight though the housing, entering the heating apparatus though a distally disposed air inlet. However, this arrangement results in liquid or condensed liquid flowing straight along the length of the housing, and leaking out of the end of the heating apparatus. This effect is exacerbated due the orientation in which electronic cigarettes are usually held by users, i.e. with the distal ends of the heating apparatus arranged vertically. The provision of a laterally disposed air inlet ensures that any liquid will collect at the bottom of the housing and be prevented from leaking out of the heating apparatus. In one example, an absorbent material may be disposed at the bottom of the housing in order to collect the accumulated liquid.

Preferably, the heating element comprises a sheet of heating material. In this way, a large surface area of heating is provided, particularly in comparison to prior art devices which utilise heating coils. A large surface area improves the efficiency of the heating apparatus and allows the temperature of operation to be reduced, thereby improving the heat distribution and fining the vaporization, i.e. ensuring fine droplets particles are generated.

Preferably, the heating element extends between a first point and a second point along the length of the housing, and the air inlet is located at a position between the first and second points, i.e. the air inlet is located at a position along the length of the housing that is adjacent to the heating element.

Preferably, the heating element comprises a sheet of heating material comprising slots extending inwardly from an edge of the sheet. In this way, a meandering current path is provided along the heating element, resulting in different concentrations of current along the path. Areas of relatively high current density become hotter than areas of relatively low current density, thus establishing a temperature gradient across the heating element. The sheet may be provided with slotted edges along the two longer sides of the sheet. In alternative examples, the sheet may be formed such that it follows a serpentine path.

The housing may comprise a first housing portion and a second housing portion that cooperatively engage along the length of the housing to define an interface, and wherein the heating element is supported in the interface between the first and second housing portions. In this way, the heating element is securely supported within the housing, whilst enabling liquid to be supplied to the heating element along the entire length of the housing.

Preferably, the air inlet is located at the interface. In this way, the structural integrity of the housing portions is maintained and a compact device is provided. Moreover, by providing the air inlet at the interface between the first housing portion and the second housing portion, as opposed to engineering an air inlet that extends through an otherwise solid portion of the housing, the ease of manufacturing the heating assembly is improved as additional material does not have to be removed from the housing to create the air inlet. Advantageously, by forming the air inlet between the first housing portion and the second housing portion, rather than within the first housing portion or the second housing portion, the strength of each housing portion is improved and the housing is less prone to failure and/or cracking.

Preferably, the heating apparatus comprises a liquid supply configured to supply liquid to the heating element. In one example, the liquid supply at least partially surrounds the housing and is configured to directly interface with the heating element along the length of the housing. In this way, a compact device is provided which delivers a reliable supply of liquid to the heating element along the length of the housing. This ensures a consistent vapour is generated and delivered to the user. Moreover, direct interfacing of the heating element with the liquid supply removes the requirement for an additional wick component, thereby reducing the cost and complexity of the heating apparatus.

The liquid supply may be a liquid store, i.e. a container arranged to hold an aerosol generating liquid, which is arranged such that the heating element is in contact with the liquid in use. In this way, liquid from the liquid store is drawn directly through the heating element as liquid is vaporised.

Preferably, the heating element comprises a sheet of heating material comprising a wicking structure for transporting liquid from the liquid supply by capillary action. The sheet of heating material may comprise a mesh of electrically conductive fibres. In this way, the heating element also acts as a wick, thereby removing the requirement for an additional discrete wick element, and reducing the total number of components. This reduces the cost of manufacture and also leads to an improved efficiency of the heating operation. In one example, the mesh of conductive fibres may comprise a sintered random array of fibres. In another example, the mesh of fibres may comprise a regular woven pattern of fibres.

The liquid supply may be arranged to supply liquid to the heating element through a first portion of the interface, and the air flow inlet arranged to transport air to the heating element through a second portion of the interface. Preferably, the first and second portions of the interface are on opposite sides of the housing. In this way, a compact arrangement of components is provided.

Preferably, an air flow coming from the air inlet can be adjusted to alter air flow to the heating element. Preferably, the size of the air inlet can be adjusted to alter air flow to the heating element. The heating apparatus may comprise a sliding member configured to adjust the size of the air inlet. In this way, the user is able to alter properties of the vapour by interacting with the sliding member. In particular, adjusting the sliding member to yield a large size of air inlet provides a greater influx of air, thereby increasing the amount of vapour generated and thus inhaled by the user. Alternatively, a small size of air inlet reduces the influx of air, thereby reducing the amount of vapour delivered to the user. In one example, the sliding member may be a mechanical slider that can be manually adjusted by the user. In an alternative example, the sliding member may be electronically controlled by the user.

The air inlet may comprise a first series of apertures, and the heating apparatus may comprise a sliding member having a second series of apertures, wherein the sliding member is arranged to be movable relative to the housing such that air flow to the heating element can be adjusted by adjusting the degree of alignment between the first and second series of apertures. In this way, the air influx to the heating element is uniformly distributed along the length of the housing, whilst also providing precise control of the overall level of air flow into the heating apparatus. In addition, the sliding member may reinforce the function of preventing leakage as the air inlet can be closed between each use. This is not possible with prior art devices comprising distally disposed air inlets, as the air inlets usually sit between the battery and the cartomizer and are thus inaccessible. In an alternative arrangement, the air inlet may comprise a single elongate gap along the length of the housing.

Preferably, the air flow path is arranged to direct air along a portion of the length of the heating element such that the air is preheated prior to being transported over the remainder portion of the heating element. In this way, a reduced amount of heat energy is lost to the ambient air, or used in the inadvertent heating of other device components. Therefore, the amount of energy required to heat and vaporise the liquid is reduced, and the efficiency of the heating apparatus is improved. Moreover, the vapour may be provided to the user at a more favourable temperature, therefore improving the user experience. This benefit is realised through the provision of a side air inlet, which allows air to be routed along the length of the housing before contacting the heating element.

The heating apparatus may comprise an absorbent material located at an end portion of the housing adjacent to the heating element. In this way, condensed liquid that has accumulated at the bottom of the housing may be collected.

In one arrangement, the heating element may comprise a resistive heating element. In another arrangement, the heating element may comprise an inductive heater.

According to another aspect of the invention there is provided an aerosol generating device comprising a heating apparatus as set out above.

According to another aspect of the invention there is provided a consumable for an aerosol generating device, the consumable comprising a heating apparatus as set out above.

### BRIEF DESCRIPTION OF THE DRAWINGS

Embodiments of the invention are now described, by way of example, with reference to the drawings, in which:

FIG. 1A is a schematic view of a heating apparatus comprising a side air inlet in an embodiment of the invention;

FIG. 1B is an alternative view of the heating apparatus depicted in FIG. 1A illustrating the sliding member;

FIG. 2 is a schematic top view of a heating element in an embodiment of the invention;

FIG. 3A is a schematic view of a heating apparatus comprising multiple side air inlets in an embodiment of the invention;

FIG. 3B is an alternative view of the heating apparatus depicted in FIG. 3A illustrating the sliding member;

FIG. 4 is a schematic view of a heating apparatus comprising a side air inlet in an embodiment of the invention; and

FIG. 5 is a schematic view of a heating apparatus comprising multiple side air inlets in an embodiment of the invention.

### DETAILED DESCRIPTION

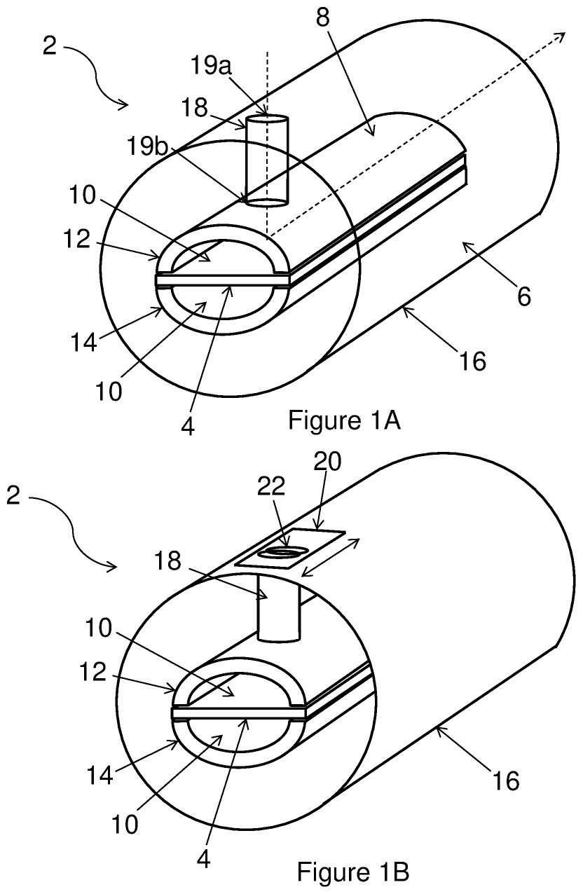

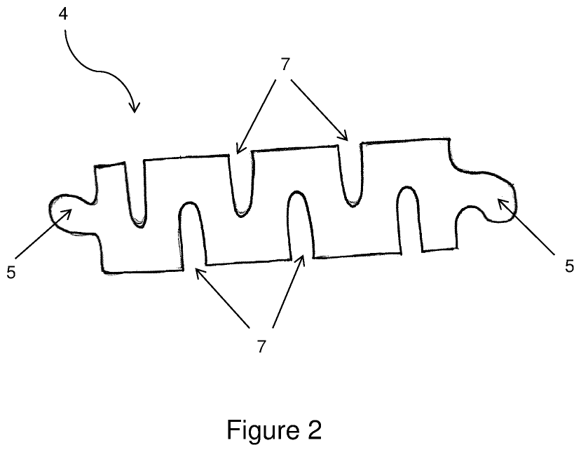

FIG. 1 shows a heating apparatus 2 in an embodiment of the invention that comprises a heating element 4, a liquid store 6, and a housing 8. The heating apparatus 2 is configured to be set in an aerosol generating device comprising a battery and a mouthpiece. In some examples, the heating apparatus 2 may be or may be comprised in a replaceable cartridge or consumable.

In use, the heating element 4 is arranged to receive electrical energy from the battery in order to generate an aerosol by heating an aerosol generating liquid. The aerosol generating liquid is drawn onto the heating element 4 from the liquid store 6 via capillary action. In this example, the liquid store 6 is disposed between the housing 8 and an outer casing 16 of the heating apparatus 2 and is configured to hold the aerosol generating liquid. One or more air flow channels 10 are provided in the housing 8, and configured to, on user inhalation, direct air from outside the heating apparatus 2 through the air flow channels 10 and toward the mouthpiece of the aerosol generation device. This means that aerosol that has been generated by heating aerosol generating liquid on the heating element 4 will be carried along the air flow channel 10 to exit the device.

The heating element 4 comprises a sheet of electrically conductive fibres. The term “sheet” refers to a shape with a thickness many times smaller than its length or breadth. A sheet is a piece of material with an extensive surface area, which in some examples may be flat or planar, but in other examples may be folded or warped. A sheet is not required to be a continuous or solid piece of material, but may comprise a mesh of fibres. The skilled person will appreciate that alternative arrangements of electrically conductive fibres may also be used as a heating element which do not resemble a sheet. For example, an elongated or rod-like heating element may be used. The fibres form a porous network, thereby providing the heating element 4 with wicking properties. Hence, the provision of an additional wicking element to transport vaporisable liquid from the liquid store 6 is not required within the heating apparatus 2.

The fibres of the heating element 4 may be made of a metal, such as stainless steel, non-stainless steel, iron, copper, tungsten, aluminium, brass, Nichrome, Kanthal, Cupronickel and other alloys, or any other metal (element, compound or alloy). Alternatively, the fibres may be made of a non-metal material such as molybdenum disilicide, silicon carbide and other ceramics or semiconductors, or any other non-metal.

In one example, the heating element 4 may comprise a sintered mesh with a random arrangement of fibres. In another example, the heating element 4 may comprise a regular woven pattern of fibres.

The heating apparatus 2 and housing 8 are substantially cylindrical. Thus, as will be used herein, the “length” of the heating apparatus 2 or housing 8 refers to the direction parallel to the axis of the cylinder, i.e. the dimension in which the heating apparatus 2 or housing 8 is elongated. Similarly, the “length” of the heating element 4 refers to its elongate axis which points along the cylindrical axis of the housing 8. The term “lateral” refers to the direction perpendicular to the “length”. The skilled person will appreciate that the heating apparatus 2 and housing 8 are not limited to be cylindrical, and may be formed in many other shapes, with the “length” being defined by the most elongated dimension.

The heating element 4 is mounted in the housing 8. The housing 8 includes a first housing portion 12 placed above the top major side of the heating element 4 and a second housing portion 14 placed below the lower major side of the heating element 4 such that the heating element 4 is held between the two housing portions 12, 14. The housing 8 acts as a vaporisation chamber which is configured to collect generated aerosol within the inner spaces of the two housing portions 12, 14.

The heating element 4 is exposed to the liquid store 6 which surrounds the housing 8. The edge portions of the first and second housing portions 12 and 14, when constructed, form a gap or interface in which the heating element 4 is held, thereby exposing the edges of the heating element 4 to the liquid store 6 along the length of the housing 8. This configuration allows aerosol generating liquid from the liquid store 6 to be uniformly and reliably supplied to the heating element 4 along its length, and to be further drawn across the heating element 4 via capillary action.

In one example, the edges of the heating element 4 may extend beyond the outer limits of the housing 8. In an alternative example, the edges of the heating element 4 may be level or retracted from the outer limits of the housing 8, and aerosol generating liquid from the liquid store 6 configured to penetrate within the gaps between first and second housing portions 12, 14. In either case, the edges of the sheet of heating element 4 are in direct fluid communication with the liquid store 6, such that an additional wicking element is not required to transport vaporisable liquid from the liquid store 6 to the heating element 4. In one example, the thickness of the heating element 4 may be slightly smaller than the gap between the first and second housing portions 12, 14 in order to provide an additional capillary channel for supplying liquid from the liquid store 6 to the heating element 4 (or for supplying air and acting as an air inlet 18 as described further below).

An air inlet 18 is disposed on a lateral portion of the heating apparatus 4, i.e. air enters the heating apparatus 4 through a side entrance disposed at a location along the length of the heating apparatus 4. This arrangement prevents condensed liquid from leaking out of the heating apparatus 4 through the air inlet 18, and instead leads to the condensed liquid collecting at the distal end of the housing 4. In one example, an absorbent material may be disposed at the end of the housing 4 to collect the condensed liquid.

The air inlet 18 comprises an outer aperture 19a in the outer casing 16 and an inner aperture 19b in the housing 8. In this way, a channel is formed extending from the outer casing 16 through the liquid store 8 to the housing 8 such that air enters the heating apparatus 4 perpendicular to the length of the housing 8. The provision of a channel extending through the liquid store 8 means that only a minor reduction in storage capacity of the liquid store 6 is required in order to route air through the side of the heating apparatus 4 and into the housing 8.

In this example, the inner and outer apertures 19a, 19b of the air inlet 18 are substantially circular apertures. However, it will be readily understood by the skilled person that the air inlet 18 may comprise any other shape of aperture, and the inner and outer apertures 19a, 19b may differ in size and/or shape. Moreover, in some embodiments, the liquid store 6 and outer casing 8 may be arranged so that the air inlet only extends through the housing 8, and not the outer casing 8, such that the outer aperture 19a is absent.

The size of the air inlet 18 may be adjusted to vary the level of air flow into the heating apparatus 4. A larger size of air inlet 18 increases the air flow into the device, whereas a smaller size of air inlet 18 decreases the air flow. As illustrated in FIG. 1B, the size of the air inlet 18 may be adjusted using a sliding member 20. The sliding member 20 comprises a sliding aperture 22 that is preferably the same size as the air inlet 18. In use, the user may slide the sliding member 20 to substantially align the sliding aperture 22 with the outer aperture 19a, thereby maximising the size of the air inlet 18 and thus the air flow into the device. If the user wants to decrease air flow into the device, the sliding member 20 may be adjusted to reduce the degree of alignment between the sliding aperture 22 and the outer aperture 19a. In this way, a greater portion of the sliding member 22 can be made to cover the outer aperture 19a, thereby reducing the size of the air inlet 18.

In alternative embodiments, the sliding member 20 may be arranged to adjust the size of the opening of the inner aperture 19b. Moreover, the skilled person will appreciate that the mechanism for adjusting the size of the air inlet 18 is not limited to a sliding member 20. Any other type of adjustable vent, valve or mechanism suitable for varying a size of the air inlet 18 may be used.

In this example, the air inlet 18 is arranged perpendicular to the major plane of the sheet of heating element 4. However, the skilled person will appreciate that the air inlet 18 may be disposed in a lateral portion of the housing 8 in any orientation along the length of the heating apparatus 2. For example, the air inlet 18 may be disposed so that air is supplied to at least a portion of the gap between the first and second housing portions 12, 14.

The air flow path through the heating apparatus 2 may be configured such that after entering through the air inlet 18, air is routed near to the heating element 4, preferably along its length, without making direct contact with the heating element 4. In this way, ambient temperature air may be preheated before being passed over and directly contacting the heating element 4.

FIG. 2 shows a schematic top view of the heating element 4 in an embodiment of the invention. The heating element 4 has two contact ends 5 which may be connected to a power source (not shown). In use, an electric current passes through the heating element 4 between the contact ends 5, thereby causing the heating element 4 to generate heat. The heating element 4 also includes a plurality of slots 7, which are arranged to cause an electric current to follow a serpentine path as it flows between the two contact ends 5. This results in different concentrations of current along the path, and the establishment of temperature gradients across the heating element. In alternative arrangements, the heating element 4 may comprise a simple shape, such as a rectangle, and different current concentrations may be established across the heating element 4 by alternative means.

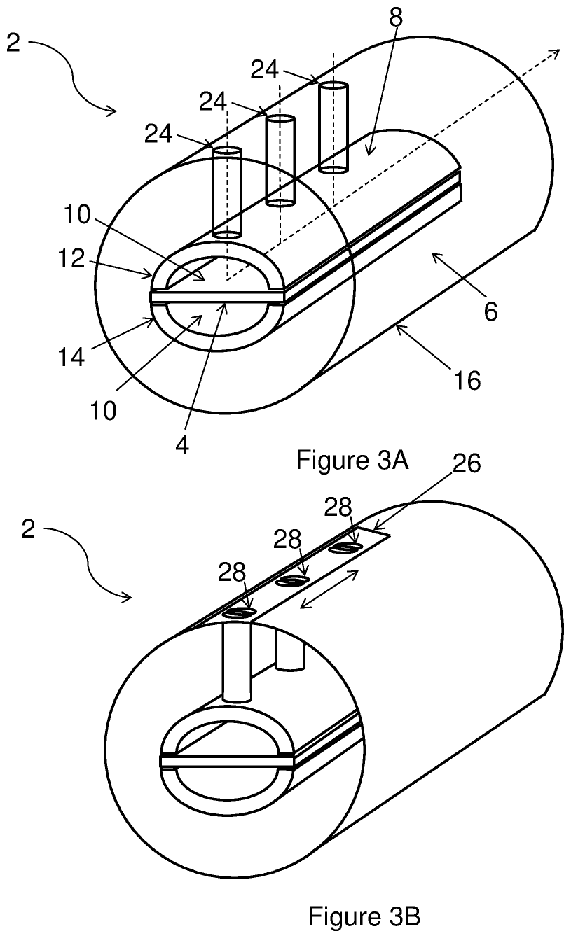

FIGS. 3A and 3B show another embodiment of the heating apparatus 2 according to the invention, wherein the heating apparatus comprises a series of air inlets 24. Preferably, the air inlets 24 are positioned along the length of the heating apparatus 2, i.e. each of the air inlets 24 are disposed in a lateral portion of the housing 8, preferably also extending through a lateral portion of the outer casing 16, and are arranged in a line extending along the heating apparatus 2. In this way, air may be supplied along the length of the heating element 4 resulting in a more consistent and reliable vaporisation operation. Alternatively, the plurality of air inlets 24 may be disposed in other arrangements on the heating apparatus 2, depending on operational requirements.

Similar to the previous embodiment, a sliding member 26 is provided on the outer casing 16. However, in this embodiment, the sliding member 26 comprises a series of sliding apertures 28, i.e. holes in the sliding member 26, which have substantially the same size and arrangement as the air inlets 24 in the heating apparatus 2. In this way, the sliding member 26 may be positioned such that the series of sliding apertures 28 align with the series of air inlets 24, thereby ensuring each of the air inlets 24 is fully exposed, i.e. open to the external air, thereby maximising air flow into the device. The sliding member 26 may be adjusted to reduce the degree of registration between the air inlets 24 and the sliding apertures 28. Misalignment between the air inlets 24 and the sliding apertures 28 results in a smaller area of opening of each of the air inlets 24, and therefore reduces air flow into the heating apparatus 2.

In alternative embodiments, the sliding member 26 may only comprise a single aperture. For example, the sliding member 26 may comprise a single rectangular aperture extending over the line of air inlets 24 along the length of the heating apparatus 2. Actuation of the sliding member 26 in a direction perpendicular to the line of air inlets 24 will simultaneously adjust the area of each air inlet 24 exposed to external air. It will be appreciated that the size of the air inlets 24 may be adjusted using an alternative mechanism, such as any other type of adjustable vent, valve or mechanism suitable for varying a size of a plurality of air inlets 24.

In alternative embodiments, the sliding member 26 may be provided on the housing 8.

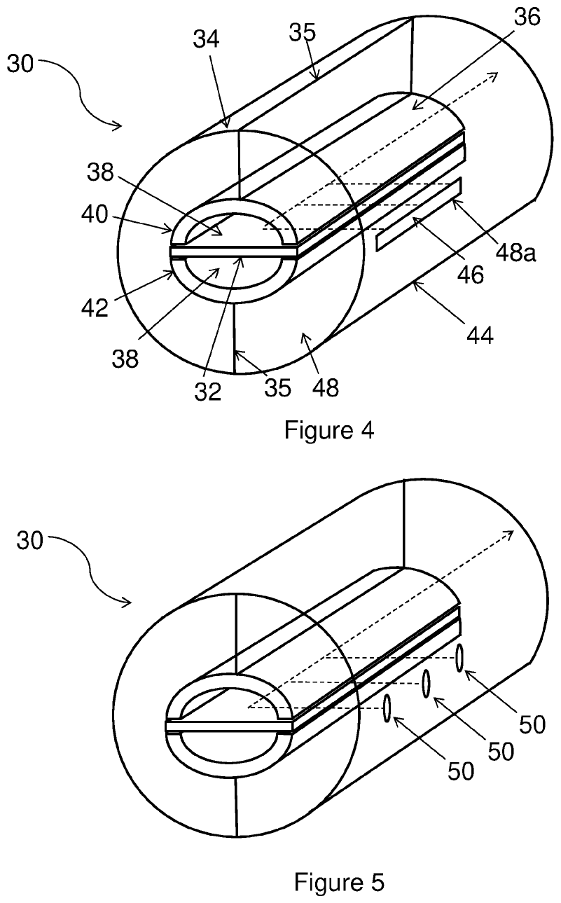

FIG. 4 shows another embodiment of a heating apparatus 30 according to the invention. Similar to the previously described embodiments, the heating apparatus 30 comprises a sheet of heating element 32 supported between first and second housing portions 40, 42 of a housing 36.

In this embodiment, however, a liquid store 34 only partially surrounds the housing 36 so that the liquid store 34 interfaces with only one edge of the heating element 32 along the length of the housing 36. Dividers 35 prevent liquid from the liquid store 34 from contacting the opposite edge of the heating element 32. In this way, the gap between the first and second housing portions 40, 42 on the side of the housing 36 that is not in fluid communication with the liquid store 34 can be used as a lateral air inlet 46.

In this example, the dividers 35 separate the volume between the outer casing 44 and the housing 36 to form the liquid store 34 and a chamber 48 that are substantially the same size, i.e. the dividers 35 lie in a central plane along the length of the heating apparatus 30. However, the skilled person will appreciate that the dividers 35, or other form of liquid store 34 container boundary, may be located at any position within the housing apparatus 30 provided at least one lateral liquid-free passage is formed between the outer casing 44 and one of the gaps between the first and second housing portions 40, 42.

The interface between the first and second housing portions 40, 42 comprises a gap in which the heating element 32 is supported. In one example, the thickness of the heating element 32 may be slightly smaller than the gap between the first and second housing portions 40, 42, thereby providing an channel that may act as the lateral air inlet 46 through the housing 36, i.e. the at least one inner aperture 48b (not pictured) of the air inlet 46 is located between the heating element 32 and one of the first and second housing portions 40, 42. In an alternative example, the heating element 32 may comprise a sheet of heating material having slots along its edges. In this way, the interface between the first and second housing portions 40, 42 will comprise channels coinciding with the slots in the edge of the heating element 32. Hence, the air inlet 46 may be arranged to supply air through at least one of the channels along the interface, i.e. the at least one inner aperture 48b (not pictured) of the air inlet 46 coincides with at least one of the slots in the heating element 32 supported between the first and second housing portions 40, 42.

The air inlet 46 comprises an outer aperture 48a extending along the length of the outer casing 44, coincident with at least one of the gaps between the first and second housing portions 40, 42. In this way, air may be supplied to the heating element 32 along its length. In this example, the outer aperture 48a comprises an elongate slot or vent. However, other types of outer aperture 48a may be used, depending on the operational requirements of the heating apparatus 30. For example, in the embodiment depicted in FIG. 5, a series of circular apertures 50 are disposed along the length of the heating apparatus 30, extending in a line on the outer casing 44 that lies in the same plane as the sheet of heating element 32.

The skilled person will appreciate that, similar to the previously described embodiments, a sliding member or other mechanism may be used to vary the size of the air inlet 46 (i.e. adjust the size of the opening of the outer aperture 48a and/or the inner aperture 48b) in order to control the level of air flow into the heating apparatus 30.

1. A heating apparatus for an aerosol generating device, comprising:
a heating element supported within a housing and extending along a length of the housing; and
an air flow path arranged to transport air over the heating element,
wherein the air flow path comprises an air inlet located on a lateral portion of the housing with respect to the length of the housing.

2. The heating apparatus of claim 1, wherein the heating element comprises a sheet of heating material.

3. The heating apparatus of claim 1, wherein the heating element extends between a first point and a second point along the length of the housing, and the air inlet is located at a position between the first and second points.

4. The heating apparatus of claim 1, wherein the housing comprises a first housing portion and a second housing portion that cooperatively engage along the length of the housing to define an interface, and wherein the heating element is supported in the interface between the first and second housing portions.

5. The heating apparatus of claim 4, wherein the air inlet is located at the interface.

6. The heating apparatus of claim 4, further comprising a liquid supply configured to supply liquid to the heating element.

7. The heating apparatus of claim 6, wherein the heating element comprises a sheet of heating material comprising a wicking structure for transporting liquid from the liquid supply by capillary action.

8. The heating apparatus of claim 7, wherein the sheet of heating material comprises a mesh of electrically conductive fibres.

9. The heating apparatus of claim 1, wherein the heating element comprises a sheet of heating material comprising slots extending inwardly from an edge of the sheet.

10. The heating apparatus of claim 6, wherein the liquid supply is arranged to supply liquid to the heating element through a first portion of the interface, and wherein the air inlet is arranged to transport air to the heating element through a second portion of the interface.

11. The heating apparatus of claim 10, wherein the first and second portions of the interface are on opposite sides of the housing.

12. The heating apparatus of claim 1, wherein an air flow coming from the air inlet can be adjusted to alter air flow to the heating element.

13. The heating apparatus of claim 12, wherein a size of the air inlet is adjustable to alter air flow to the heating element.

14. The heating apparatus of claim 1, wherein the air inlet comprises a first series of apertures.

15. The heating apparatus of claim 1, wherein the air flow path is arranged to direct air along a portion of a length of the heating element such that the air is preheated prior to being transported over a remainder portion of the heating element.

16. The heating apparatus of claim 13, further comprising a sliding member configured to adjust the size of the air inlet.
